(19) United States
(12) Patent Application Publication
(10) Pub. No.: US 2005/0162493 A1
(43) Pub. Date: Jul. 28, 2005

(54) Method and Apparatus for Reducing Adhesion and Abrasion When Printing on a Thermal Printer

(76) Inventor: Lawrence W. Gross, Boca Raton, FL (US)

Correspondence Address: JOHN C. SMITH, ESQ., 4800 NORTH FEDERAL HIGHWAY, SUITE A-207, BOCA RATON, FL, 33431, US

(21) Appl. No.: 10/707,915

(22) Filed: Jan. 23, 2004

(51) Int. Cl. G01D 11/00

(52) U.S. Cl. 347/100

(57) ABSTRACT

A method of reducing adhesion and abrasion when printing tickets on thermal printers which uses a series of fluoradditive and/or fluorosurfactant chemical additives which, when added to the ink, eliminates the tackiness and the resulting adhesion. Alternatively, instead of adding these additives to the ink, these same chemicals may be added to the protective coating on the print head and will also prevent the ticket from sticking to the print head when used in this manner. The chemical additives, also result in reduced friction which is generated by moving the print media past the printhead under pressure. The chemical additives are fluoradditives and/or fluorosurfactants.

### BACKGROUND OF INVENTION

1. Technical Field

The present invention relates to thermal printers. In particular, it relates to the use of a class of chemical additives to eliminate adhesion and abrasion problems commonly experienced in the use of thermal ticket printers. The chemical additive may be added to either the ticket material or the print head itself to reduce the adhesion to a level below which it causes no disruption in the printing process, and to reduce abrasion created during movement of the ticket past the printhead.

2. Background

A wide variety of activities require access to the activities via the purchase of a ticket. These activities include sports events, movie theaters, concerts, etc.. In addition, the ticket printers used to print tickets can be located in a wide variety of locations. Historically, individuals who purchased tickets, such as theater tickets, would go into the theater to purchase the tickets. In this situation, the ticket machine was in a relatively protected environment which was not subject to wide fluctuations of temperature or humidity.

Over time, thermal ticket machines have been placed in locations where they are subject to a much wider range of environmental factors. For example, theaters now have outside booths where ticket sellers print tickets for the public. These booths often exposed printers to a wider range of temperatures and humidity. More recently, self-service ticket stations, similar to ATMs, have been developed to provide individuals with the ability to order in print their own tickets without assistance from a tickets seller. Its machines are found outside of movie theaters, as well as another environment such as airline terminals, etc . . . In addition to the sale of tickets, external thermal printers have been developed for many applications, such as gas station pump receipts, etc . . .

Operation of thermal ticket printers in a wider variety of weather environments has increased problems related to generation of tickets by thermal printers. In particular, there is a normal level of adhesiveness and abrasion which occurs during the printing process. When adhesiveness is too great, then the printing process may be interfered with resulting in lower quality printing, and potential printer error. Likewise, excessive abrasiveness will eventually degrade printer performance. It would be desirable to have a method of reducing both adhesion and abrasion during the printing process to improve print quality, and to reduce instances of print failure.

The adhesion problem is directly related to the nature of the media used in the printing process. Tickets are manufactured by placing layers of ink on top of a treated (thermal) ticket material. Due to the nature of thermal media, the ticket normally has a degree of tackiness. The heat resistant inks used in manufacturing the tickets also add some tackiness to the surface of the ticket. In an indoor printing environment, where factors such as humidity are well controlled, adhesion is not a serious problem. However, in high humidity environments, such as those often found in outdoor printing venues, the tackiness of the ticket surface may cause the ticket to adhere to the printer mechanism.

Thermal printing is based upon transferring heat from the print head to the media (paper or plastic). In order to effectively transfer the heat, there are a few pounds of pressure between the print head and the paper. In most (low to medium humidity) environments, this is not a problem. However, in high humidity, the combination of pressure and humidity breaks down the inks and/or top coating of the paper causing an adhesion between the paper and the print head. In the worst case, this prevents the ticket from moving. In less severe cases, the ticket remains adhered for a short period of time causing a registration problem.

Until recently, most thermal ticket printers were used indoors (low to medium humidity) where there was little opportunity for sticking. Additionally, most printers were used in manned operations where a ticket jam could be easily cleared by the operator. In recent years, there has been a significant increase in both outdoor and unmanned ticketing operations. In these applications, even an occasional ticket jam is a major problem. As a result, the need for a method of reducing adhesion has become increasingly important due to the changing environment where many printers are now used. It would be desirable to have a method of reducing adhesion between the ticket and the printhead during the thermal print process.

Another problem associated with printing is the wear caused by movement, under pressure, of tickets over the thermal printhead. Both the ticket and the printhead specific coefficients of friction based on the materials they are fabricated from. It would be desirable to have a method of reducing the friction associated with movement of the ticket passed the printhead during the printing operation. A reduction in friction will produce registration errors caused by friction which interferes with movement of the ticket as the printhead. Of course, the reduction in friction will also reduce wear and tear on the printhead and extend the life of the printer.

While providing a wide variety of thermal printing devices, the prior art has failed to provide a method of reducing adhesion caused by tacking us on the surface of a ticket, and failed to provide a solution that would simultaneously reduce abrasion which eventually causes premature printhead failure due to wear.

### SUMMARY OF INVENTION

The present invention provides a series of fluoradditive and/or fluorosurfactant chemical additives which, when added to the ink, eliminates the tackiness and the resulting adhesion. Alternatively, instead of adding these additives to the ink, these same chemicals can be added to the protective coating on the print head and will also prevent the ticket from sticking to the print head when used in this manner. The chemical additives, also result in reduced friction which is generated by moving the print media past the printhead under pressure. The chemical additives are fluoradditives and/or fluorosurfactants.

### BRIEF DESCRIPTION OF DRAWINGS

FIG. 1 is a side view of a preferred embodiment of a ticket having an upper surface treated with a layer of fluoradditives and/or fluorosurfactants.

FIG. 2 is a top view of an alternative preferred embodiment in which only a portion of the upper surface of the ticket is treated with a layer of fluoradditives and/or fluorosurfactants.

FIG. 3 is a side edge view of another alternative preferred embodiment in which the protective coating on the surface of the thermal printhead is treated with a layer of fluoradditives and/or fluorosurfactants instead of treating the surface of the ticket.

FIG. 4 is a side edge view of another alternative embodiment of the invention in which both the ticket and the surface of the thermal printhead are treated with fluoradditives and/or fluorosurfactants.

### DETAILED DESCRIPTION

Prior to a detailed discussion of the figures, a general overview of the system will be presented. The invention provides a solution for the adhesion and abrasion problems that occur normally, but are exacerbated in hostile environments such as those with high humidity. As discussed above, the trend in using thermal printers and outdoor or expose environments has led to a wider variety of temperatures and/or humidity extremes. As a result, the normal performance of a ticket as it moves past the thermal printhead under pressure has integrated, resulting in more frequent jamming, and more frequent registration problems. This problem is further exacerbated by the fact that many externally located printers are unattended. This increases the severity of the print problems because when using unattended outdoor thermal printing devices there is no attendant present to correct the problem for the consumer.

The invention solves this problem by providing a series of chemical additives, which are commercially available from DuPont(TM), among others, which eliminates the tackiness and the resulting adhesion when added to the ink. In addition, when these chemicals are added to the protective coating on the print head, they will prevent the ticket from sticking to the print head.

DuPont's Zonyl® product line includes both fluoradditives (MP1100, MP1200, MP1300, MP1400, TE3667N, TE5069AN, etc.) and fluorosurfactants (FSO, FSA, FSN, etc.). These chemicals are commonly added to inks, paints, plastics, adhesives, waxes and metal finishing solutions for a variety of reasons as shown below:

1. Improved abrasion, scratch and scuff resistance

2. Increased slip, surface lubricity and block resistance

3. Improved chemical resistance

4. Improved stain resistance

5. Improved scrub resistance

At the present time, fluoradditive and/or fluorosurfactant chemical additives, such as those discussed above, appear in a number of hair products, in lithographic plate processing, in ink-jet ink compositions and in thermal dye transfer processes. There is no known use in the area of direct thermal printing either to reduce tackiness/adhesion problems or abrasion problems in either media or thermal printhead technology. The present invention provides a method of using these chemical additives to solve both problems in the area of thermal printing technology.

The use of fluoradditive and/or fluorosurfactant chemical additives on the ticket results in a non-stick surface without disturbing the heat transfer characteristics critical to efficient thermal ticket printing. In a preferred embodiment, the Zonyl fluoroadditives are typically mixed into the ink in percentages from 1% to 13% by weight, while the Zonyl fluorosurfactants are mixed at between 0.01% and 0.05%. Of course, fluoroadditives obtained from other commercial sources may vary in strength. Therefore, while these preferred percentages have been found to provide adequate results, the use of different percentages, especially when using fluoroadditives from other commercial sources, is not critical and may vary. In the ideal implementation, the fluoroadditive/ink mixture will be applied over the entire front surface of the ticket. However, similar benefits will be derived by applying the fluoroadditive/ink mixture only to the area which remains in continued contact with the print head, While the fluoroadditives are preferably mixed with the ink, the use of and alternative carrier liquid to apply the fluoroadditives is consistant with the invention.

The use of fluoroadditives on the ticket will allow the use of the ticket manufacturer to produce stick-free tickets. However, another approach is to modify the printer such that it can operate with any ticket stock. This is accomplished by adding the fluoroadditives to the ceramic based coating that protects the print head. In this manner, all tickets (whether or not they were treated with fluoroadditives) would be able to operate stick-free with the fluoroadditive treated print heads. The fluoroadditives are preferably added to the liquid ceramic or other protective coating in similar concentrations to those stated above.

Fluoroadditives are finely divided white powders of polytetrafluoroethylene (PTFE) resin. The commercially available Zonyl MP1000 through MP1600 are fluoradditive powders with differing particle sizes. Zonyl 3667N is a basic solution containing 60% concentration of PTFE. However, due to the small particle size involved, the 3667N does not appear to significantly improve the non-stick characteristics of the ticket. It has been found that fluorosurfactants, such as those discussed above, provide minimal non-stick qualities, apparently as a result of the extremely small particle sizes involved. However, both the fluoradditive powders and fluorosurfactants greatly reduce the abrasiveness of the ticket surface.

Examples of suitable commercially available fluorosurfactants are those available from DuPont's line of Zonyl Products, and include:

1. FSO

FSO is a nonionic chlorinated surfactant having the following composition:

R₁CH₂CH₂O(CH₂CH₂O)ₓH

2. FSN

FSN is a nonionic chlorinated surfactant having the following composition:

R₁CH₂CH₂O(CH₂CH₂O)_{y}H

3. FSH

FSH is a nonionic chlorinated surfactant having the following composition:

R₁CH₂CH₂O(CH₂CH₂O)_{w}H

4. FS-300

FS-300 is a nonionic chlorinated surfactant having the following composition:

R₁CH₂CH₂O(CH₂CH₂O)_{z}H

where W<X<Y<Z.

Having discussed the principles and advantages of the invention in general, we now turn to a discussion of the figures which illustrate embodiments of the invention.

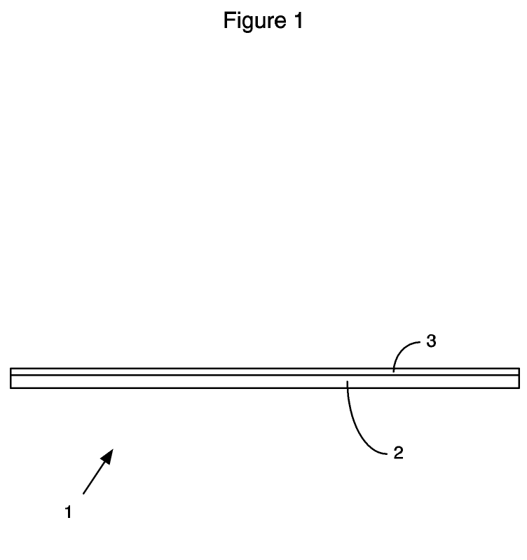

FIG. 1 is a side view of a preferred embodiment of a ticket 1 having a conventional ticket media 2 with an upper surface treated with a layer of fluoradditives and/or fluorosurfactants 3. The ticket media 2 is a conventional prior art ticket stub. Prior to printing, the ticket media 2 is prepared for printing by treating the upper surface with a layer of fluoradditives and/or fluorosurfactants 3. Many tickets are preprinted with specific ornamental designs prior to imprinting specific data, such as dates, seat locations, etc.. The fluoradditives and/or fluorosurfactants 3 can be added to and used to preprint the ornamental designs in a variety of ways. In the preferred embodiment, the fluoradditives and/or fluorosurfactants 3 are headed to be used to create the ornamental designs. This provides a blank ticket which is ready for printing data and which has its surface covered with a layer of fluoradditives and/or fluorosurfactants 3. The fluoradditives and/or fluorosurfactants 3 reduce adhesion and abrasion on the ticket numeral on is being imprinted with data by the thermal printer. This helps to prevent adhesion of the ticket to the printhead which will result in ticket jams and registration problems. In addition, the ink used during the process of printing data on the blank ticket 1 may also have the fluoradditives and/or fluorosurfactants 3 included to further reduce the possibility of adhesion or abrasion.

Those skilled in the art will realize that while the fluoradditives and/or fluorosurfactants 3 can be applied to the ticket 1 by painting it to the ink, it is also possible to treat the ticket 1 by adding the fluoradditives and/or fluorosurfactants 3 to any other suitable carrier liquid and then treating the ticket 1 with the carrier liquid.

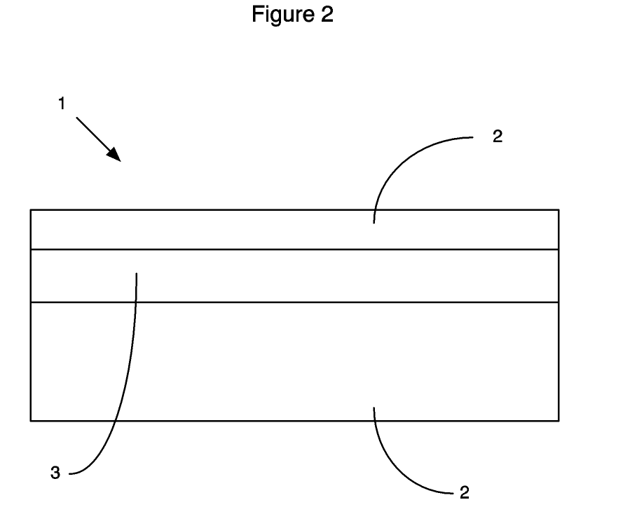

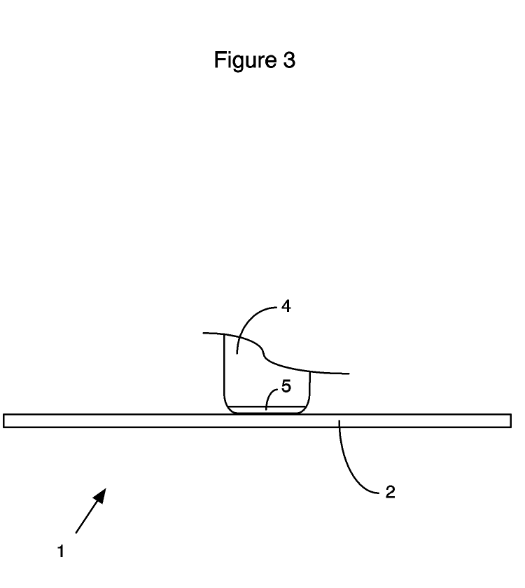

FIG. 2 is a top view of an alternative preferred embodiment of the ticket 1 in which only a portion of the upper surface of the ticket media 2 is treated with a layer of fluoradditives and/or fluorosurfactants 3. Since the printhead 4 (shown below in FIG. 3) does not come in contact with the entire surface of a typical ticket 1, is possible to realize the advantages of the invention by only treating the portion of the ticket 1 which comes in contact with the printhead 4. This is illustrated by showing a layer of fluoradditives and/or fluorosurfactants 3 which does not cover the entire upper surface of the ticket media 2. As this ticket 1 is moved through under the printhead 4 during the printing process, only the treated area will come in contact with the printhead 4.

FIG. 3 is a side edge view of another alternative preferred embodiment in which the protective coating on the surface 5 of the thermal printhead 4 is treated with fluoradditives and/or fluorosurfactants instead of treating the surface of the ticket 1. The advantages associated with this embodiment is that the thermal printer can now use ordinary ticket 1 media instead of having to treat every ticket 1.

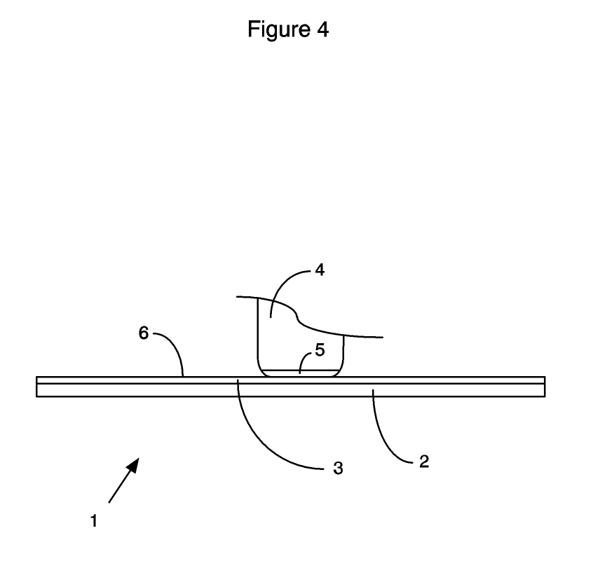

FIG. 4 is a side edge view of another alternative embodiment of the invention in which both the surface 6 of the ticket 1 is treated with a layer of fluoradditives and/or fluorosurfactants 3 and the surface 5 of the thermal printhead 4 is also treated with fluoradditives and/or fluorosurfactants.

As a result of reducing the adhesion which occurs during a thermal printing process, machine failures due to jamming are reduced, as well as failures in print alignment. The reduction in adhesion is particularly important in situations where environmental factors are outside of conventional norms. This is a frequent problem on outdoor thermal printing systems are used.

While the invention has been described with respect to a preferred embodiment thereof, it will be understood by those skilled in the art that various changes in detail may be made therein without departing from the spirit, scope, and teaching of the invention. For example, the type of fluoradditive or fluorosurfactant may be anything suitable for its purpose, the size and shape of the ticket or printhead can vary. The type and number of fluoradditives or fluorosurfactants can vary, etc. Accordingly, the invention herein disclosed is to be limited only as specified in the followclaims.

1. A method of reducing adhesion in thermal printers, including the steps of:
treating the surface of ticket stock with fluoradditives and/or fluorosurfactants by mixing fluoroadditives into thermal printer ink in percentages from 1% to 13% by weight.

2. A method of reducing adhesion in thermal printers, including the steps of:
treating the surface of ticket stock with fluoradditives and/or fluorosurfactants by mixing fluorosurfactants into thermal printer ink in percentages from 0.01% and 0.05% by weight.
